(19) United States
(12) Patent Application Publication
(10) Pub. No.: US 2003/0192410 A1
(43) Pub. Date: Oct. 16, 2003

(54) Screwdriver having a removable ring tab with printed or punched words or diagrams

(75) Inventor: Yang Ming Li, Changhua (TW)

Correspondence Address: BACON & THOMAS, PLLC, 625 SLATERS LANE, FOURTH FLOOR, ALEXANDRIA, VA, 22314

(73) Assignee: Hung Yu Industrial Co., Ltd., Changhua (TW)

(21) Appl. No.: 10/121,574

(22) Filed: Apr. 15, 2002

(51) Int. Cl. B25B 15/00

(52) U.S. Cl. 81/436

(57) ABSTRACT

A screwdriver is equipped with a removable ring tab on which words or diagrams are provided. The screwdriver has a handle portion and a shank portion and on the handle portion is disposed a recessed groove in which the ring tab of a like or different color can be housed. The ends of the ring tab are provided with a retaining protrusion and a retaining cavity respectively for locking the ring tab in place. Words or diagrams of different sized can be printed or punched on the ring tab instead of on the handle portion whereby even mistakenly printed or punched words or diagrams can be easily removed by replacement of the ring tabs without discarding the whole screwdrivers in mass production. Besides, the printed or punched words or diagrams are not easily abraded away in long term operation.

### BACKGROUND OF THE INVENTION

The present invention relates to a screwdriver having a removable ring tab on which printed or punched words or diagrams are provided. The screwdriver has a handle portion and a shank portion and on the handle portion is disposed a recessed groove in which the ring tab of a like or different color can be housed. The ends of the ring tab are provided with a retaining protrusion and a retaining cavity respectively for locking the ring tab in place. Words or diagrams of different sized can be printed or punched on the ring tab instead of on the handle portion whereby even mistakenly printed or punched words or diagrams can be easily removed by replacement of the ring tabs without discarding the whole screwdrivers in mass production. Besides, the printed or punched words or diagrams are not easily abraded away in long term operation.

As shown in FIG. 1, a conventional screwdriver is provided with words or diagrams in 3 ways. The first way is effected by directly printing words 12 on the handle portion 11 of a screwdriver 10; the second way is effected by directly putting embossed words or diagrams 12′ on the handle portion 11 of the screwdriver 10 in an integral production process; the third way is effected by mechanically pressing words or diagrams 12″ on the shank 13 of a screwdriver 10.

Such prior art screwdrivers have the following disadvantages in practical operation:

1. The printed words or diagrams 12 on the handle portion 11 are easily abraded away as a result of direct contact of hands with the handle portion 11 of a screwdriver 10, making the specification of a screwdriver hard to recognize.

2. The embossed words 12′ are relatively hard to apply to the handle portion by means of plastic molding, and it is time consuming and costly to put words or diagrams in the molds.

3. As shown in FIG. 2, the shank 13 of the screwdriver 10 provided with pressed words or diagrams 12″ is easily broken when the front end 14 of the screwdriver is used to pry against an object; or the shank 13 is easily bent at the processed point of the shank 13.

4. Once the printed or punched words or diagrams are not defected, whole screwdrivers must be discarded, resulting in economical loss in mass production.

### SUMMARY OF THE INVENTION

Therefore, the primary object of the present invention is to provide a screwdriver with a removable ring tab which has printed or punched words or diagrams disposed thereon and is registered with a recessed groove on the handle portion of a screwdriver whereby screwdrivers can be produced simultaneously with the ring tabs, and only mistakenly processed ring tabs instead of all screwdrivers are replaced.

Another object of the present invention is to provide a screwdriver with a ring tab which is removably registered with a recessed groove defined on a handle portion of a screwdriver with ease and speed.

One further object of the present invention is to provide a screwdriver with a ring tab which can be printed or punched with words or diagrams thereon and concealed in a recessed groove so as to prevent the words or diagrams on the ring tab from being abraded away.

One still further object of the present invention is to provide a screwdriver with a ring tab concealedly registered with a recessed groove on the handle portion of a screwdriver and the colors of the handle portion and the ring tab can be different from each other so as to make the screwdriver attractive or eye appealing in appearance.

### BRIEF DESCRIPTION OF THE DRAWINGS

FIG. 1 is a perspective diagram of a prior art screwdriver;

FIG. 2 is a diagram showing the operation mode thereof;

FIG. 3 is a perspective diagram of the exploded components of the screwdriver of the present invention;

FIG. 4 is a plane diagram showing the assembly of the present invention.

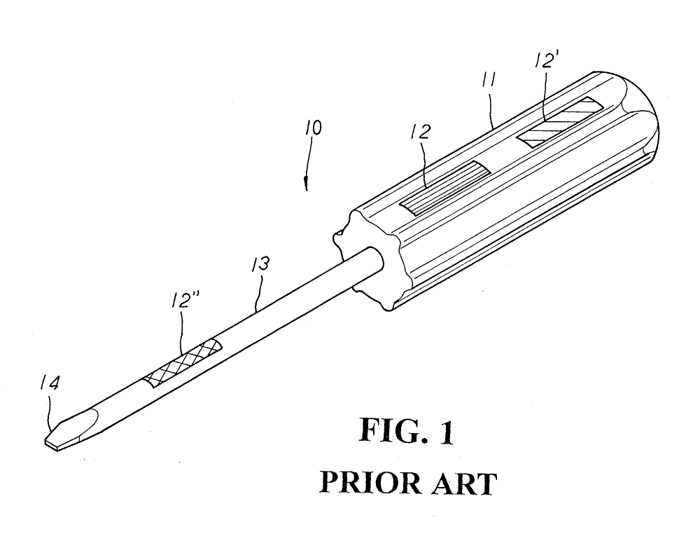

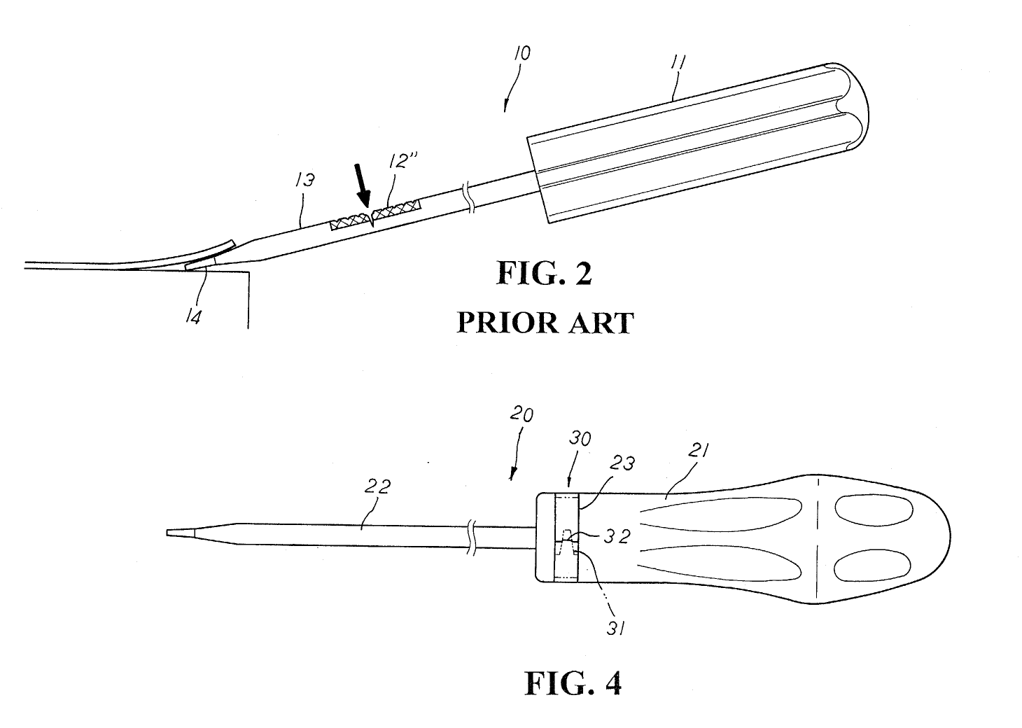

### DETAILED DESCRIPTION OF THE PREFERRED EMBODIMENTS

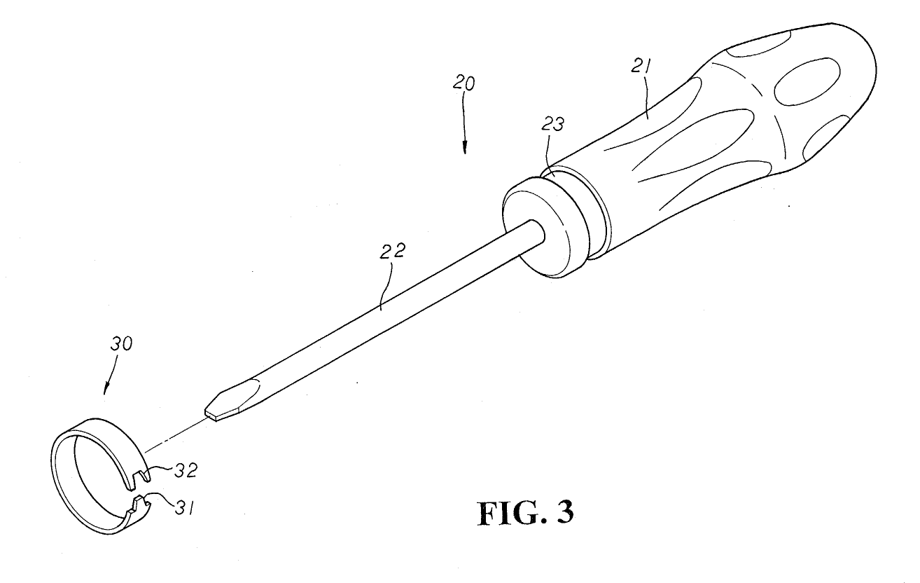

Referring to FIG. 3, the screwdriver 20 of the present invention comprises a handle portion 21, a shank portion 22 and a ring tab 30. A peripheral groove 23 of a proper depth is disposed on the handle portion 21. The shape of the ring tab 30 made in conformance to the peripheral groove 23 is resilient and of a color which may be different from the handle portion 21. The ring tab 30 has two split ends, one is a retaining protrusion 31 and the other is a retaining cavity 32.

As shown in FIG. 4, in assembly, the ring tab 30 printed or punched with words or diagrams of various desired sizes can be registered with the peripheral groove 23 of the screwdriver 20 with the retaining protrusion 31 engaged with the retaining cavity 32 so as to make the ring tab 30 lie flush with the round surface of the handle portion 21 of the screwdriver 20.

I claim:

1. A screwdriver having a removable ring tab on which printed or punched words or diagrams are provided, comprising a handle portion, a shank portion and a ring tab; wherein a peripheral recessed groove of a proper depth is disposed on the handle portion, said ring tab has a shape made in conformance to said peripheral recessed groove so as to permit said ring tab to be housed in said recessed groove.

2. The screwdriver having a removable ring tab as claimed in claim 1 wherein said ring tab is a resilient plate.

3. The screwdriver having a removable ring tab as claimed in claim 1 wherein said ring tab is selectively made in different color from said handle portion.

4. The screwdriver having a removable ring tab as claimed in claim 1 wherein said words or diagrams of various desired sizes can be registered with said peripheral groove of said handle portion with a retaining protrusion engaged with said retaining cavity so as to make said ring tab lie flush with a round surface of said handle portion of said screwdriver.
